(19) United States
(12) Patent Application Publication
(10) Pub. No.: US 2024/0258809 A1
(43) Pub. Date: Aug. 1, 2024

(54) MOBILE POWER SUPPLY SYSTEM COMPRISING CASCADED MULTI-LEVEL INVERTER

(71) Applicant: instagrid GmbH, Ludwigsburg (DE)

(72) Inventors: Andreas SEDLMAYR, Pforzheim (DE); Sebastian BERNING, Stuttgart (DE)

(21) Appl. No.: 18/289,687

(22) PCT Filed: Apr. 26, 2022
(86) PCT No.: PCT/EP2022/061098

§ 371 Date: Nov. 6, 2023

(30) Foreign Application Priority Data
May 6, 2021 (DE) 10 2021 111 865.4

(51) Int. Cl. H02J 7/00; H01M 50/213; H01M 50/24; H01M 50/284

(52) U.S. Cl. CPC H02J 7/0063; H01M 50/213; H01M 50/24; H01M 50/284; H02J 7/0013; H02J 7/0045; H02J 2207/20

(57) ABSTRACT

A mobile energy supply system (100) is suitable to be used as an electrical socket and comprises: a battery module (230) comprising a plurality of battery cells (130); a controller (120) configured to selectively connect each of the at least one battery modules to an output (150) of the energy supply system to provide a selected AC voltage at the output; and an inverter of the cascaded multilevel topology type.

### CROSS-REFERENCE TO RELATED APPLICATIONS

This application is a 35 U.S.C. § 371 National Stage patent application of PCT/EP2022/061098, filed on 26 Apr. 2022, which claims the benefit of German patent application 10 2021 111 865.4, filed on 6 May 2021, the disclosures of which are incorporated herein by reference in their entirety.

### TECHNICAL FIELD

The present disclosure relates to mobile energy supply systems suitable to be used as an electrical socket.

### BACKGROUND

Conventionally, mobile energy supply systems for use as electrical sockets for powerful tools like diamond drills, high-pressure cleaners, and industrial vacuum cleaners are almost exclusively based on combustion technology. This holds true especially in the context of machines with an electrical input power above 1 kW. Due to increasing concerns regarding environmental and health issues caused by exhaust gases and noise, it is desirable to operate such devices based on electrical energy.

A practicable solution are portable battery storage systems which provide a standard AC voltage directly at their output, for example 230V at 50 Hz or 115V at 60 Hz. This output can be realised as a standard electrical socket suitable for use with standard appliances. Such battery storage systems are available in a large number of different designs.

However, the available devices have significant disadvantages restricting their practicality. The design of such battery storage systems is a trade-off between output power and weight. Battery storage systems with a high output power greater than 2.5 kW typically have a weight higher than 20 kg and are thus not suitable to be carried by a single person with a view to current occupational health and safety requirements. Alternative or in addition to that, they usually offer insufficient storage capacity (below 1 kWh). Battery storage systems with a lower output power are lighter but cannot be used for power-intensive applications as described above.

In addition to the average output power provided, the so-called overload capacity is an important factor in battery storage systems. Commercially available battery storage systems typically provide 50% more power for a short time (i.e., for a few seconds) than during continuous operation. High loads such as machines that use so-called capacitor motors (i.e., single-phase asynchronous machines), however, require up to ten times more current during motor start-up. While this is generally not a problem when those machines are run on the main grid, this is currently seen as a factor effectively impeding the use of battery storage systems in such applications.

In summary, the gravimetric power density of battery storage systems with an AC voltage output, both in continuous use and in particular for coping with load peaks, is not sufficient to meet the requirements for mobile use of large machines.

Notwithstanding the above, the technical limitations of current battery storage systems can be shown to result from yet another aspect, namely from the power density of the current inverter converting the DC voltage of the battery cells into a suitable AC voltage. In addition, adding a current converter into the battery storage systems for charging the battery storage unit from an alternating voltage source contributes significantly to the weight of the battery storage unit.

Document U.S. Pat. No. 8,994,336 B2 discloses a battery storage system in which the battery cells are arranged in series in such a way that their voltage is above the peak voltage of the alternating voltage to be generated. This improves both the overload capacity and the power density of the battery storage system. However, an inverter of the usual type is still used to generate the alternating voltage. A charger used to charge the batteries disadvantageously increases the overall weight of the device.

In this specification, where reference has been made to external sources of information, including patent specifications and other documents, this is generally for the purpose of providing a context for discussing the features of the present disclosure. Unless stated otherwise, reference to such sources of information is not to be construed, in any jurisdiction, as an admission that such sources of information are prior art or form part of the common general knowledge in the art.

The present disclosure provides a mobile energy supply system which overcomes or at least partially ameliorates some of the abovementioned disadvantages or which at least provides the public with a useful choice.

### STATEMENTS

In a first aspect, the present disclosure may be said to broadly consist in a mobile energy supply system suitable to be used as an electrical socket, the mobile energy supply system comprising
at least one battery module, each of the at least one battery modules comprising a plurality of battery cells;
a controller configured to selectively connect each of the at least one battery modules to an output of the energy supply system to provide a selected AC voltage at the output; wherein
the mobile energy supply system comprises between 50 and 150 battery cells, each battery cell having a weight of between 40 g and 100 g; and the mobile energy supply system comprises a cascaded multi-level inverter topology.
   The inventive mobile energy supply system is capable of providing a significantly higher power density than state-of-the-art battery storage systems. Thus, for the first time, unrestricted performance as compared to a mains connection can be offered at a portable weight.

In various embodiments, each of the at least one battery modules comprises
an input terminal;
an output terminal;
a bridge circuit controlled by the controller, the bridge circuit configured to selectively connect the input terminal and the output terminal in one of a battery mode and a bridge mode; wherein
in the battery mode, the input terminal and the output terminal are connected with the battery cells; and
in the bridge mode, the input terminal and the output terminal are connected while the battery cells are bridged.

In certain embodiments, the plurality of battery cells is connected in series or in parallel in each of the at least one battery modules.

In certain embodiments, the mobile energy supply system comprises at least two battery modules, wherein the controller is configured to selectively connect each of the at least two battery modules in series to provide the selected AC voltage at the output of the energy supply system.

In various embodiments, the mobile energy supply system comprises between 4 and 50 battery modules, each battery module comprising between 3 and 15 battery cells.

In various embodiments, the at least one battery module comprises a single battery module, wherein individual battery cells of the single battery module which cannot be disconnected from the single battery module are configured to be individually controllable by the controller.

In various embodiments, each battery cell has a cylindrical shape.

In various embodiments, each battery cell has a diameter of between 14 mm to 22 mm and an axial length of between 60 mm and 75 mm.

In various embodiments, each of the at least one battery modules has an end-of-charge-voltage of less than 60V.

In various embodiments, each of the at least one battery modules stores an amount of energy of less than or equal to 100 Wh.

In various embodiments, each of the at least one battery modules is configured to individually be separated from or added to the mobile energy supply system, and wherein each of the at least one battery modules is configured to individually be electrically controlled by the controller.

In various embodiments, the mobile energy supply system provides a power density of greater than 150 W/l and greater than 150 W/kg, and an energy density of greater than 100 Wh/l and greater than 100 Wh/kg.

In various embodiments, the mobile energy supply system is configured to employ passive cooling while providing a power density of above 100 W/l and above 100 W/kg.

In various embodiments, the mobile energy supply system has a waterproof construction while providing a power density of above 100 W/l and above 100 W/kg.

Other aspects of the disclosure may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification and claims means “consisting at least in part of”. When interpreting statements in this specification and claims which include that term, the features, prefaced by that term in each statement, all need to be present but other features can also be present. Related terms such as “comprise” and “comprised” are to be interpreted in the same manner.

The entire disclosures of all applications, patents and publications, cited above and below, if any, are hereby incorporated by reference.

This disclosure may also be said broadly to consist in the parts, elements and features referred to or indicated in the specification of the application, individually or collectively, and any or all combinations of any two or more of said parts, elements or features, and where specific integers are mentioned herein which have known equivalents in the art to which this disclosure relates, such known equivalents are deemed to be incorporated herein as if individually set forth.)

### BRIEF DESCRIPTION OF THE DRAWINGS

The disclosure will now be described by way of example only and with reference to the drawings in which:

FIG. 1: shows a mobile energy supply system according to an embodiment of the disclosure; and

FIG. 2: shows a battery module used in a mobile energy supply system according to an embodiment of the disclosure.

### DETAILED DESCRIPTION OF THE DRAWINGS

In the above drawings similar features are generally indicated by similar numerals.

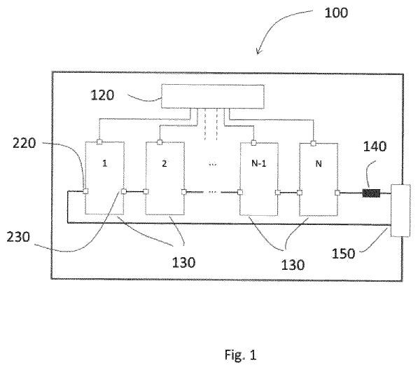

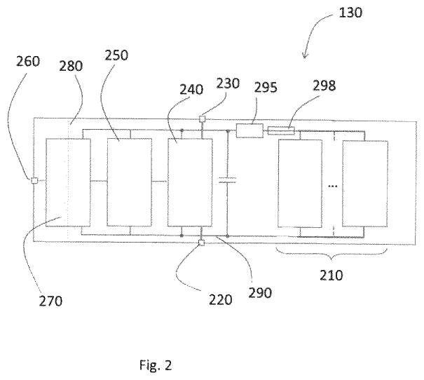

In one embodiment now described in relation to FIG. 1, a mobile energy supply system 100 comprises a plurality of 1 . . . N battery modules 130, each of the plurality of battery modules 130 comprising a plurality of battery cells 210 which are depicted in FIG. 2. In the embodiment of FIG. 1, the energy supply system 100 comprises N battery modules 130 connected in series. In other embodiments however, the energy supply system may comprise a single one, two, or more battery modules 130.

The energy supply system 100 further comprises a controller 120 configured to selectively connect each of the plurality of battery modules 130 to an output 150 of the energy supply system 100 to provide a selected AC voltage at the output.

According to certain embodiments, the mobile energy supply system 100 may comprise between 50 and 150 battery cells 210, each battery cell 210 having a weight of between 40 g and 100 g.

Further according to the embodiment of FIG. 1, the mobile energy supply system 100 system comprises a cascaded multi-level inverter topology.

Various embodiments of the mobile energy supply system 100 comprise between 4 and 50 battery modules 130, each battery module 130 comprising between 3 and 15 battery cells 210. Each of the plurality of battery cells 210 may have a cylindrical shape, have a diameter of between 14 mm to 22 mm, and an axial length of between 60 mm and 75 mm.

Each of the battery modules 130 may have end-of-charge-voltage of less than 60V and may store an amount of energy of less than or equal to 100 Wh.

As shown in FIG. 2, in addition to the plurality of battery cells 210, which is connected in series or in parallel in each of the battery modules 130, each of the battery modules 130 comprises an input terminal 220, an output terminal 230, and a bridge circuit 240, wherein the bridge circuit 240 configured to selectively connect the input terminal 220 and the output terminal 230 in one of a battery mode and a bridge mode.

In the battery mode, the input terminal 220 and the output terminal 230 are connected with the plurality of battery cells 210, whereas in the bridge mode, the input terminal and the output terminal are connected while the battery cells are bridged.

The battery module 130 of FIG. 2 further comprises a link 290 connecting the electrical components contained in the battery 130 with each other, and a control device 250 which in turn receives input from controller 120 to operate the bridge circuit 240 to selectively bridge the battery module 130 by short-circuiting the input terminal 220 and the output terminal 230 or to connect the plurality of battery cells 210 in series or in parallel between the input terminal 220 and the output terminal 230. In addition, a control connection 260 and an isolation device 270 for galvanic isolation—indicated in FIG. 2 by isolation barrier 280—of at least one control signal are provided in the battery module 130. The control device 250 and at least one side of the isolation device 270 are permanently supplied with a voltage provided by the plurality of battery cells 210 or, respectively, with a voltage derived therefrom.

Further in FIG. 2, the battery module 130 comprises a separator 295 and a fuse 298.

In certain embodiments, the isolation device 270 and/or the control device 250 are not implemented, or at least not completely implemented, in the same structural unit that contains the plurality of battery cells 210. However, also in these embodiments, at least one isolation device 270 and one the control device 250 are permanently assigned to a battery module 120.

It is a favourable aspect that in some embodiments, each of the at least one battery modules 130 is configured to individually be separated from or added to the mobile energy supply system 100, and wherein each of the at least one battery modules 130 is configured to individually be electrically controlled by the controller 120.

Herein, in embodiments, the battery modules 120 can be switched such that additional voltage values can be generated at the output 150 which do not correspond to the sum of the module voltages. To this end, the battery modules 120 are switched such that the desired voltage is realised as an average value over a certain period of time. This can be achieved using pulse width modulation. Using a smoothing coil 140 in a series configuration as shown in FIG. 1, the time average of the voltage is then made available at the output 150.

In certain embodiments, the at least one battery module 130 comprises a single battery module 130, wherein individual battery cells 210 of the single battery module 130 (which cannot be disconnected from the single battery module 130) are configured to be individually controllable by the controller 120.

In other words, in embodiments having one or more battery modules 130 that cannot be physically separated, the cascaded multi-level converter architecture is configured in a way that subsets of the respective battery module(s) 130 (i.e., one or more battery cells 210) can be switched together to act as a module from an electronic point of view.

The system architecture described above allows for the usage of semiconductor switches with a low blocking voltage because the blocking voltage does not have to be designed for the blocking voltage of the alternating voltage generated at the output. Rather, the blocking voltage is chosen only taking into account the maximum voltage of a single battery module 120.

For example, in embodiments of the mobile energy supply system 100 which employ a battery module 120 comprising six lithium-ion battery cells 210 connected in series, the maximum voltage is 6*4.2V=25.2V. In these embodiments, semiconductor switches having a blocking voltage of around 40V or lower are used for this purpose with good results.

According to a favourable aspect of this configuration, the static losses of such a switch are around a hundred times lower than the static losses of a comparable semiconductor switch of the same size having a blocking voltage of 650V, which can be found in prior art devices having comparable power outputs.

As a result, the development of local heat at the switch which is also around a hundred times lower than in prior art systems. As an example, semiconductor switches exhibiting 1 mOhm flow resistance in their closed state, which are used in certain embodiments, produce only around 0.25 W at a current magnitude of 16 A. In various embodiments, this heat output is passively distributed and released into the environment, and no dedicated heat sink is required. This significantly reduces the weight of the mobile energy supply system 100.

In addition to the reduction in weight, the reduction in thermal losses also increases the efficiency of voltage conversion. As a result, the electrical energy stored in the plurality of battery cells 210 can be used more efficiently, which leads to a longer operating time of the mobile energy unit 100. This is particularly advantageous in mobile applications, since the amount of energy contained in the energy unit 100 is limited and directly related to the weight of the energy supply system 100 via the energy density of the plurality of battery cells 210.

In certain embodiments, battery cells 210 with a particularly low internal resistance are used in the battery modules 130. As a consequence, significantly less heat is built up at plurality of battery cells 210 than at the semiconductor switches. A thermally favourable connection of the semiconductor switches to the battery cells 210 effects that the waste heat from the semiconductor switches can be dissipated directly to the large heat capacity of the plurality of battery cells 210. This way, passive cooling of the semiconductor switches over the entire discharging period of the battery modules 130 is achieved. In other words, the semiconductor switches can dissipate thermal energy to the plurality of battery cells 210 over the entire discharging period without causing excessive heat build-up at the plurality of battery cells 210 or at the semiconductor switches. This is ideally ensured by a suitable design even under unfavourable ambient conditions, for example in the case of increased ambient temperature or exposure to sunlight.

Using the above technology, various embodiments of mobile energy supply systems 100 are configured to employ passive cooling while providing a power density of above 100 W/l and above 100 W/kg. In various embodiments, the plurality of battery cells 210 comprise lithium-ion battery cells with less than 40 mOhm internal resistance (DC) and a total weight of less than 550 g per battery module 130, in combination with MOSFET semiconductor switches with less than 5 mOhm resistance (RDSon).

In certain embodiments, an even more advantageous design is achieved by using lithium-ion battery cells for the plurality of battery cells 210, the lithium-ion battery cells exhibiting less than 30 mOhm (DC) internal resistance and a total weight of the plurality of battery cells 210 of less than 400 g per battery module 130 in combination with MOSFET semiconductor switches exhibiting less than 3 mOhm volume resistance (RDSon).

The passive cooling that is achieved in some embodiments of the mobile energy supply system 100 allows to dispense with moving mechanical parts, such as fans, for example, which increases reliability and service life of the mobile energy unit 100. In addition, such embodiments comprise housings without any openings which are hitherto required in state-of-the-art mobile energy units to invoke a cooing air flow. As a result, the susceptibility to dirt and moisture of the mobile energy unit 100 is greatly reduced. This way, some embodiments of the mobile energy supply system 100 have a waterproof construction while providing a power density of above 100 W/l and above 100 W/kg.

The architecture presented above also allows the size and weight of the smoothing coil 140 used to be reduced considerably. Partly, this follows from the reduction of the switched voltage levels which has been described above: In a conventional high-voltage inverter voltage levels between 375V and 425V are switched to generate an alternating voltage with effective 230V or, respectively, 325V peak voltage. Contrastingly in exemplary embodiments of the mobile energy supply system 100 comprising battery modules 130 each having six lithium-ion battery cells 210, only voltage steps of a magnitude of 25.2V have to be switched.

By reducing the voltage levels, the voltage ripple at the output 150 is reduced by the same factor, i.e. the required inductance of the smoothing coil 140 can be reduced by this factor as well. In embodiments of the mobile energy supply system 100, this inductance can be reduced at least a factor of 10 in practice. Since the switching processes for the modulation of the output voltage can be distributed across all battery modules 130 in the mobile energy supply system 100, the switching losses for each semiconductor switch are reduced on average by a factor of N corresponding to the number of battery modules 130 in the mobile energy supply system 100.

This allows for the realisation of a significantly higher switching frequency, for example 50-100 kHz. The required inductance of the smoothing coil 140 is thus reduced again by at least 50 percent. Overall, therefore, a reduction of the inductance of the output coil 150 of at least a factor of 20 can be achieved, resulting in a significant weight reduction, which in some embodiments has been found to amount to more than 1 kg.

In certain cases, the desired output voltage exhibiting the required residual ripple can even be achieved without additional pulse width modulation due to the small voltage levels, i.e. the smoothing coil 140 can completely be dispensed with.

In order to reduce the weight of the plurality of battery cells 210 to a minimum, the number of battery cells 210 used in embodiments of the mobile energy supply system 100 is reduced to a minimum congruously. In order to output a distortion-free AC voltage, it is necessary that the sum of the module voltages of each battery module 130 corresponds at least to the peak voltage of the AC voltage provided at the output 150 at any point in time. Since the voltage of the plurality of battery cells 210 changes as a function of the amount of energy stored therein, it must be ensured in particular that this condition is still met even when the plurality of battery cells 210 are almost completely discharged.

In a lithium-ion battery cell, for example, an unrestrained operation of the cell should be guaranteed at least down to a minimum cell voltage of 3V. In order to generate an alternating voltage with an effective peak voltage of 230V or, respectively, 325V, at least 108 cells are required. Similarly, for an alternating voltage of 120V, or, respectively, 170V peak voltage, at least 57 cells are required. Since part of the voltage drops under load across the battery cells 210 themselves and across other components in the current path, more battery cells 210 must be provided in practice to ensure continuous, distortion-free operation. With an amperage of 16 A effective or, respectively, 22.6 A peak value, an additional drop of 34 V must be expected, assuming an internal resistance of the power supply system of 1.5 ohms. To compensate for this voltage drop, an additional 11 cells are required. Accordingly, in embodiments of a mobile energy supply system 100 having 230 VAC/16 A output, a total of 120 lithium-ion cells are provided for, wherein it has been found in such embodiments that any number of between 108 to 120 lithium-ion cells delivers suitable results.

The mobile energy storage system 100 described above offers an extremely low output impedance and is exceptionally suitable for short-term high output currents, which enables it to be used for large electrical machines with high power consumption. In embodiments of the mobile energy supply system 100, battery cells 210 with an internal resistance of 30 mOhm are used, wherein approximately 90 cells are connected in series for a peak value of the output voltage of 325V and a cell voltage of 3.6V, corresponding to a series resistance of 2.7 Ohm. In addition to that, these embodiments employ 20 battery modules 130 having 80 semiconductor switches in total. Each semiconductor switch has a static resistance of 1 mOhm, in addition to line losses and losses at plug contacts of the battery module 130. Overall, accordingly, an internal resistance of below 3 Ohm can be assumed, i.e. the short-circuit current is above 100 A, which is also sufficient as a starting current for large electrical machines. Furthermore, 1 mOhm semiconductor switches with a blocking voltage of 40V are employed in some embodiments, which switches are able to carry or switch more than 200 A without any problems, which means that currents of such magnitude can also be achieved in some embodiments of the mobile energy units 100 without technical difficulties.

Similarly, in embodiments of the mobile energy supply system 100, a power density of greater than 150 W/l and greater than 150 W/kg, and an energy density of greater than 100 Wh/l and greater than 100 Wh/kg can be achieved.

Where in the foregoing description reference has been made to elements or integers having known equivalents, then such equivalents are included as if they were individually set forth.

Although the disclosure has been described by way of example and with reference to particular embodiments, it is to be understood that modifications and/or improvements may be made without departing from the scope or spirit of the disclosure.

1. A mobile energy supply system suitable to be used as an electrical socket, the mobile energy supply system comprising:
at least one battery nodule, each of the at least one battery modules comprising a plurality of battery cells;
a controller configured to selectively connect each of the at least one battery nodules to an output of the energy supply system to provide a selected AC voltage at the output;
wherein
the mobile energy supply system comprises between 50 and 150 battery cells, each battery cell having a weight of between 40 g and 100 g; and
the mobile energy supply system comprises a cascaded multi-level inverter topology.

2. The mobile energy supply system of claim 1, wherein each of the at least one battery modules comprises
an input terminal;
an output terminal; and
a bridge circuit controlled by the controller, the bridge circuit configured to selectively connect the input terminal and the output terminal in one of a battery mode and a bridge mode; wherein
in the battery mode, the input terminal and the output terminal are connected with the plurality of battery cells; and
in the bridge mode, the input terminal and the output terminal are connected while the plurality of battery cells are bridged.

3. The mobile energy supply system of claim 1, wherein the plurality of battery cells is connected in series or in parallel in each of the at least one battery modules.

4. The mobile energy supply system of claim 1, comprising at least two battery modules, wherein the controller is configured to selectively connect each of the at least two battery modules in series to provide the selected AC voltage at the output of the energy supply system.

5. The mobile energy supply system of claim 4, comprising between 4 and 50 battery modules, each battery module comprising between 3 and 15 battery cells.

6. The mobile energy supply system of claim 1, wherein the at least one battery module comprises a single battery module, wherein individual battery cells of the single battery module are configured to be individually controllable by the controller.

7. The mobile energy supply system of claim 1, wherein each of the plurality of battery cells has a cylindrical shape.

8. The mobile energy supply system of claim 1, wherein each of the plurality of battery cell has a diameter of between 14 mm to 22 mm and an axial length of between 60 mm and 75 mm.

9. The mobile energy supply system of claim 1, wherein each of the at least one battery modules has an end-of-charge-voltage of less than 60V

10. The mobile energy supply system of claim 1, wherein each of the at least one battery modules stores an amount of energy of less than or equal to 100 Wh.

11. The mobile energy supply system of claim 1, wherein each of the at least one battery modules is configured to individually be separated from or added to the mobile energy supply system, and wherein each of the at least one battery modules is configured to individually be electrically controlled by the controller.

12. The mobile energy supply system of claim 1 providing a power density of greater than 150 W/l and greater than 150 W/kg, and an energy density of greater than 100 Wh/l and greater than 100 Wh/kg.

13. The mobile energy supply system of claim 1, configured to employ passive cooling while providing a power density of above 100 W/l and above 100 W/kg.

14. The mobile energy supply system of claim 1, wherein the mobile energy supply system has a waterproof construction while providing a power density of above 100 W/l and above 100 W/kg.
